(19) United States
(12) Patent Application Publication
(10) Pub. No.: US 2003/0201897 A1
(43) Pub. Date: Oct. 30, 2003

(54) Tornado detection system

(76) Inventors: E. Tim Goldburt, Chappaqua, NY (US); Alexander Pakhomov, Ardsley, NY (US)

Correspondence Address: Ilya Zborovsky, 6 Schoolhouse Way, Dix Hills, NY, 11746, US

(21) Appl. No.: 10/115,318

(22) Filed: Apr. 3, 2002

(51) Int. Cl. G01W 1/00

(52) U.S. Cl. 340/601; 340/506; 73/170.16

(57) ABSTRACT

A tornado detection system has a plurality of sensors each having a body of a particulate material composed of a plurality of individual particles; and means for determining changes in electrical conductivity of the particulate material caused by seismic and acoustic vibrations; and means for connecting the sensors with one another so as to form a zone sensitive to movement of a tornado.

### BACKGROUND OF THE INVENTION

The present invention relates to systems for detecting tornados.

When a tornado is generated and moves over corresponding zones, in addition to other physical phenomena, anomalous pressure which moves on the ground surface is different from pressure in surrounding areas. As a result, the surface layer of ground in these zones obtains a forced vertical displacement with weakening oscillations which are superimposed on it. These zones have an approximately circular shape and linear transverse sizes in hundreds of meters. It is known to use small point-shaped seismic sensors or geophones for determination of zones of anomalous pressure. However, this approach is not effective and can not be used for many reasons. The main reason is that the sensors are velocity sensors and therefore they have to be combined in a single system by connecting them in series with one another. As a result, they are very sensitive to other exterior sources of seismic noise of natural and artificial origin. It is difficult to separate a signal from a tornado on the background with a significant noise. When such sensors are used as single sensors, it is also difficult to obtain a signal from the tornado on the background of noise since the signal obtained only in a single point is very difficult to be distinguished from noise.

### SUMMARY OF THE INVENTION

Accordingly, it is an object of the present invention to provide a tornado detection system, which avoids the disadvantages of the prior art.

In keeping with these objects and with others which will become apparent hereinafter, one feature of the present invention resides, briefly stated, in a tornado detection system which has a plurality of sensors each including a body of a particulate material composed of a plurality of individual particles, and means for determining changes in electrical conductivity of the particulate material caused by seismic and acoustic vibrations; and means for connecting said sensors with one another so as to form a zone sensitive to movement of a tornado.

When the system is designed in accordance with the present invention, it is significantly more accurate than the existing systems. The sensors which are utilized in the system are not velocity sensors, but instead they are displacement sensors and therefore they provide a uniform and a high sensitivity to an action of a tornado at different speeds of its displacement and the lowest influence by exterior sources of noise. A linear size of the zone of sensitivity in a horizontal plane substantially corresponds to a linear size of a zone of anomalous pressure created by tornado, or in other words it is hundreds of meters. In this case, corresponding part of the energy of tornado is most efficiently converted into a signal of the sensors. These both factors provide a better ratio of signals from tornado to and from noises generated by other sources of seismic disturbances and therefore the most reliable registration of a tornado passing above the sensor and at a certain distance from it.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view showing an elementary zone of sensitivity of a system in accordance with the present invention;

FIG. 2 is a view showing the location of two elementary zones with a corresponding equipment;

FIG. 3 is a view showing a location of the two elementary zones relative to one another;

FIGS. 4a and 4b are views showing variants of locations of the sensitive zones in signal border areas;

FIG. 5 is a view showing objects to be protected from tornado, and the location of the zones forming a signal border and information border areas.

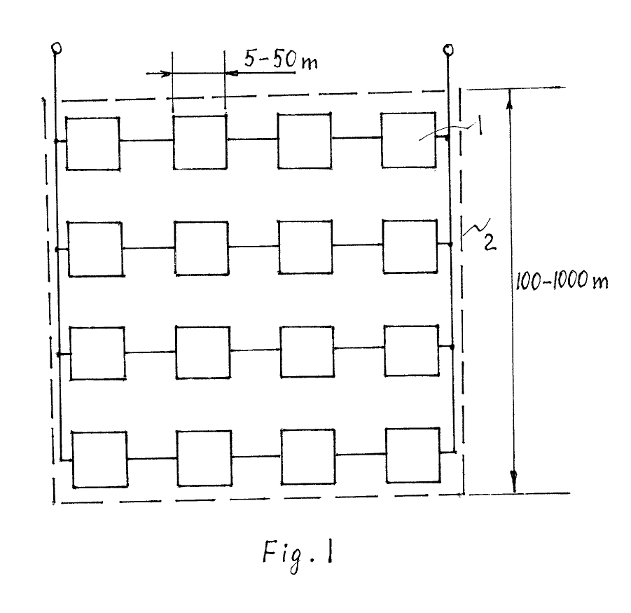

### DESCRIPTION OF THE PREFERRED EMBODIMENT

A system in accordance with the present invention has a plurality of sensors which are identified with reference numeral 1. Each sensor is formed as a displacement sensor and has of a body of a particulate material composed of electrically conductive particles, and means for determining changes in electrical conductivity or electrical resistance of the body of the particulate material, which result from a tornado-generated anomalous pressure wave moving in the ground. When such anomalous pressure wave moves, the density in the body of the particulate material changes and the degree of contact between the particles changes as well so as to change electrical conductivity and an electrical resistance of the body of the particulate material. Therefore the means for sensing changes of the electrical conductivity or electrical resistance immediately detect such changes indicative of a displacement of the anomalous pressure wave from the tornado. Such sensors are disclosed for example in our concomitant patent application “Device for Sensing Seismic and Acoustic Vibrations”, by Pakhomov, A. et al.

Each sensor can have for example a square shape with the size from 5×5 meter to 50×50 meter. The sensors 1 are electrically connected with one another in parallel or in series to form an elementary sensitivity zone that can be of any shape and size. For example 16 sensors can form a square elementary sensitive zone 2.

A distance between the sensors 1 in each elementary zone 2 must be not more than a minimum diameter of a cross-section of a tornado or a zone of abnormal pressure which is created by the tornado, minus a linear size of each sensor:

b<Dₘᵢₙ^{-a}

where b is a distance between the sensors 1 in the zone 2, Dₘᵢₙ is a minimum diameter of a zone of abnormal pressure generated by a tornado, a is a side of the square sensor.

In this case, regardless of a trajectory of movement of a tornado, at least one of the sensors of the zone will be always located under the tornado.

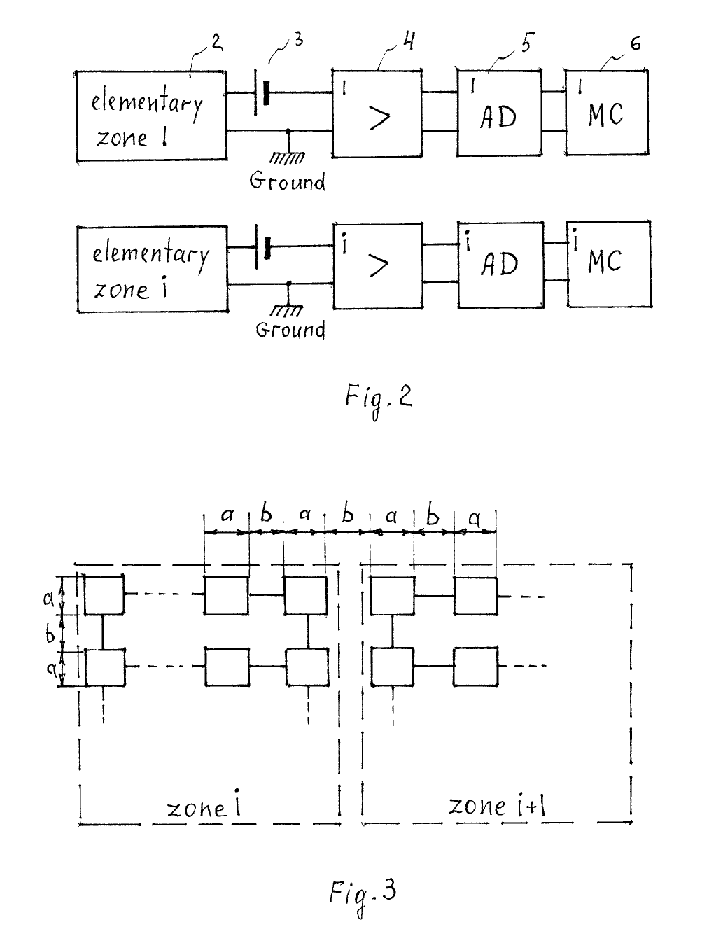

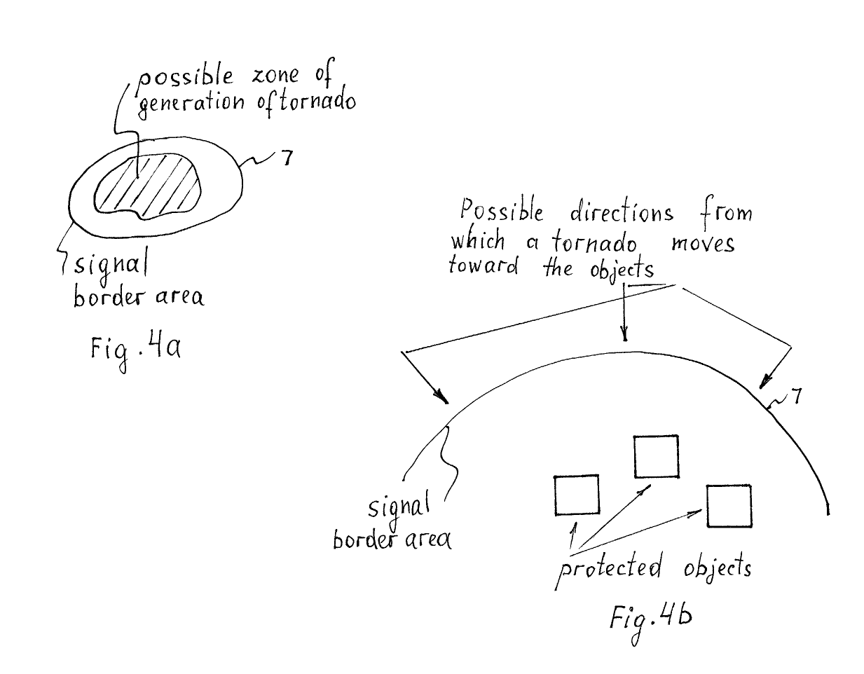

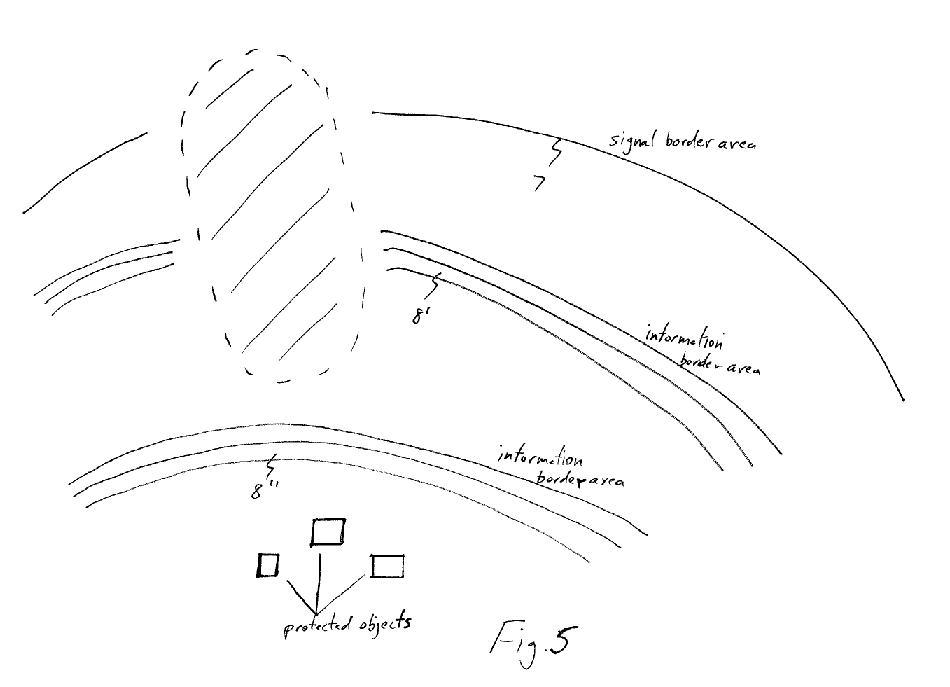

A signal from each elementary zone is supplied to an information channel of processing which is shown in FIG. 2. Each channel includes a voltage source 3, an amplifier 4, an analog/digital converter 5, and a processor 6 formed for example as a microprocessor. The voltage source supplies a voltage to the zone, and the change of the electrical conductivity is amplified in the amplifier 4, then converted into a digital signal in the converter 5 and analyzed in the microprocessor 6 to determine whether the signal is characteristic for a tornado. The microprocessor abstract of micro controller makes a decision about a presence or an absence of a tornado above the corresponding elementary zone based on the corresponding software. When the micro controller determines the presence of a tornado, it can transfer the information about it for example through a radio channel.

The zones are formed so that they form corresponding border areas, in particular a signal border area and information border areas, as identified correspondingly with reference numeral 7 for the signal border area and with reference numerals 8′ and 8″ for the information border areas.

The signal area operates for an early detection of appearance of tornado and/or approaching of the tornado and for turning on of the information areas. The signal area is located at a maximum distance from the objects to be protected, for example from a populated object, or from a service personnel which must be informed about an approaching tornado. The signal areas are located so as to surround a possible zone of generation of tornado completely or partially. In the last case, the signal areas are located transversely to the directions from which a tornado moves toward the objects to be protected. The signal areas are turned on and operate during all period of time (seasons, months, etc.) when there is a probability of generation of a tornado over zero. The signal areas are turned on and turned off in response to a radio signal from an information center of the system. The signal areas are composed of the elementary sensitive zones 2 which are arranged along a line.

The distance between the zones in the signal area is selected so that the sensors are located along the line with a pitch b as shown in the drawings. When the tornado crosses the signal area, it reaches a zone of action of one or several elementary sensitive zones. Each zone which is influenced by this sends the signal which is supplied to a single control center, and to the information areas which are explained herein below.

The location of the zone supplies a signal and a time of obtaining signal from it gives a first information about a place and a time of movement of the tornado. Depending on the length of the area, its continuity or discontinuity, is possible to use a single transceiver for several neighboring elementary zones, or even for the whole area. The signal information from each elementary zone to the transceiver in this case can be transmitted through the wires laid along the area, including the use of standard interfaces so that one cable with several conductors can be laid along the area.

The information areas subsequently determine the place and time as well as the speed and direction of movement of a tornado. Inside a signal information area, there are several border areas. Therefore when a tornado crosses these areas, a direction and speed of a tornado can be determined by processing of the signals from each of the sub areas. As a result, corresponding objects can be informed about approaching of a dangerous tornado. The information areas can be located between signal areas and objects to be protected, so as to overcome all possible and most probable directions of movement of a tornado. Signals from the corresponding zones inside each sub area and the signals of the sub areas allow identification of the speed and direction of movement of the tornado. As a result, the signal information center can obtain the required information, inform the corresponding objects and trigger an alarm. The information or control center can include a computer with a display and a printer, and a transceiver which provides a connection of information center with all areas as well as their control and generation of an alarm.

It will be understood that each of the elements described above, or two or more together, may also find a useful application in other types of constructions differing from the types described above.

While the invention has been illustrated and described as embodied in tornado detection system, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A tornado detection system, comprising a plurality of sensors each having a body of a particulate material composed of a plurality of individual particles; and means for determining changes in electrical conductivity of the particulate material caused by seismic and acoustic vibrations; and means for connecting said sensors with one another so as to form a zone sensitive to movement of a tornado.

2. A tornado detection system as defined in claim 1, wherein said sensors are arranged so that a distance between two neighboring sensors is smaller than a minimal diameter of a cross-section of a tornado minus a linear size of each of said sensors.

3. A tornado detection system as defined in claim 1, wherein said sensors form a plurality of zones arranged so as to form a signal area for an early detection of place and time of tornado formation (touchdown) and/or approaching of a tornado.

4. A tornado detection system as defined in claim 1, wherein said sensors are connected with one another so as to form a plurality of zones arranged so as to form an information area capable of detecting not only a place and a time but also a speed and a direction of movement of a tornado.

5. A tornado detection system as defined in claim 1 wherein said sensor form a plurality of zones arranged so as to form a plurality of areas, said areas extending in a direction which is transverse to a direction of movement of a tornado and are spaced from one another in the direction of movement of the tornado, one of said areas being formed as a signal area for an early detection of a tornado and/or approaching of a tornado, while the other of said areas is formed as an information area which determines not only a place and a time, but also a speed and a direction of movement of the tornado.

6. A tornado detection system as defined in claim 1; and further comprising means for processing signals obtained from said sensors and determining whether a tornado approaches said sensors or not.

7. A tornado detection system as defined in claim 5; and further comprising means for processing said signals from said signaling area and said information area and analyzing signals received from said area so as to obtain a corresponding information about the tornado.

8. A tornado detection system as defined in claim 7, wherein said processing means also include means for selectively turning on and turning off of said areas.

9. A tornado detection system as defined in claim 1; and further comprising means for triggering an alarm in response to said sensors detecting approaching of a tornado.

10. A tornado detection system as defined in claim 6, wherein said processing means include a transceiver operative for receiving signals from said sensors, controlling said sensors and triggering an alarm signal.
